(19) United States
(12) Patent Application Publication
(10) Pub. No.: US 2008/0148141 A1
(43) Pub. Date: Jun. 19, 2008

(54) Method For Encoding an Xml Document, Decoding Method, Encoding and Decoding Method, Encoding Device, Decoding Device and Encoding and Decoding Device

(75) Inventors: Jorg Heuer, Oberhaching (DE); Andreas Hutter, Munchen (DE); Andrea Kofler-Vogt, Kolbermoor (DE)

Correspondence Address: STAAS & HALSEY LLP, SUITE 700, 1201 NEW YORK AVENUE, N.W., WASHINGTON, DC, 20005, US

(73) Assignee: SIEMAENS AKTIENGESELLSCHAFT, Munich (DE)

(21) Appl. No.: 11/632,622

(22) PCT Filed: May 24, 2005
(86) PCT No.: PCT/EP05/52372

§ 371 Date: Dec. 26, 2007

(30) Foreign Application Priority Data
Jul. 14, 2004 (DE) 10 2004 034 004.8

(51) Int. Cl. G06F 17/00

(52) U.S. Cl. 715/234

(57) ABSTRACT

An XML document is encoded into a bit stream, particularly binary bit stream with at least one XML element having a simple content in which at least one absolute path is represented by a sequence of XML elements and/or XML attribute names. The XML document is represented by a tree structure. All absolute paths of the XML elements with a simple content and XML attributes are sorted according to at least one first predeterminable sorting criterion. A value representative is associated, in a value structure, with each value expression of the XML elements with a simple content and the XML attributes of the respective absolute path. The value representative is stored in the value structure according to a second sorting criterion. A path position, associated with each value representative, represents a position of the respective value representative in the tree structure in relation to the respective absolute path.

### CROSS REFERENCE TO RELATED APPLICATIONS

This application is based on and hereby claims priority to German Patent Application No. 10 2004 034 004.8 filed on Jul. 14, 2004, the contents of which are hereby incorporated by reference.

### BACKGROUND

XML (extensible markup language) is a language that makes it possible to create a structured description of the content of a document. Namespaces that are defined by the XML Schema language definitions can be used in this connection. A more detailed description of the XML Schema and the structures, data types and content models used in it may be found in publications XML Schema Part 0: Primer W3C Recommendation, 2 May 2001, XML Schema Part 1: Structures W3C Recommendation 2 May 2001 and XML Schema Part 2: Datatypes W3C Recommendation 2 May 2001, available at www.w3.org/TR/2001/REC-xmlschema-0-20010502/, www.w3.org/TR/2001/REC-xmlschema-1-20010502/and www.w3.org/TR/2001/REC-xmlschema-2-20010502/, respectively.

Methods for encoding XML-based documents in which the document is converted into an encoded binary representation are known from the related art. ISO/IEC 15938-1 Multimedia Content Description Interface—Part 1: Systems, Geneva 2002, for example, which was authored in the course of the development of an MPEG-7 encoding standard, describes methods for encoding and decoding XML-based documents.

The methods for generating a binary representation of XML-based documents that are known from the related art suffer from disadvantages in the encoding of XML-based documents for random access to encoded information. Methods of indexing data streams that enable random access to encoded data streams are known from the related art as described in TV-Anytime Specification Series S-3 on Metadata, Part-B, Version 13 and German Patent Application 10 337 825 which describes a method for generating a bit stream from an indexing tree, but these methods suffer from the disadvantage that the indexing information is of a significant size relative to the data stream indexed.

It is often necessary to read out specific content from a bit stream in response to a prior query issued by a user or to determine whether specific content is actually contained within the bit stream. A query defined by a user in this context can be formulated using a query language such as SQL or Xpath, as described for example at dxi.hrz.uni-dortmund.de:8001/docl/hrz/sqlref/sqloracle.html and www.w3.orgfTR/xpath, respectively, when the priority application was filed.

The drawback of reading out data from a bit stream is apparent, by way of example, in the case of a document created using XML (extensible markup language) that is represented in the MPEG7 BiM format. Particular reference is made to ISO/IEC 15938-1 Multimedia Content Description Interface—Part 1: Systems in respect of the MPEG7 BiM format of an XML document. A representation of this type breaks the bit stream generated up into a multiplicity of units (access units), each of which in turn consists of a multiplicity of fragments (fragment update units). The units are encoded and are sent on demand to one or more recipients as an MPEG7 BiM stream.

Regarding the querying of information from XML documents, a large number of query languages that make it possible to search for specific information in the document are already known. Reference is made at this point, by way of example, to the XPath query language already mentioned. The XPath query language enables the definition of selection criteria for filtering required information within an XML document. The objective of a query in this context may be to evaluate whether a unit of the bit stream is significant for the recipient. Alternatively a query may be used to access required information in the XML document in a targeted manner. The MPEG7 encoding method has not hitherto provided any mechanisms for the generation of the bit stream of an XML document that enable random access to specific elements of the XML document. Consequently the MPEG7 bit stream has to be decoded in order to search for elements. Decoding here produces a document in XML format again and this document can then be searched using the XPath query language. The decoding and subsequent processing of an XML document in order to search for specific content is clearly very time-consuming and is unacceptable for certain time-critical applications. Furthermore it can also encounter a problem if the decoder has only limited memory available and is unable to decode the bit stream in full. If the XPath query applied to the decoded XML document returns a negative result, moreover, the effort involved in decoding is all for nothing.

TV-Anytime (TVA), which was described at www.public.asu.edu/˜peterjn/btree/ when the priority application was filed, uses an index structure that enables random access to specific elements of a data fragment. The index structure has multiple components and includes what is known as a key index list, in which all indexed paths of a document are stored. When a query is made, these paths are compared against the query in order until a matching entry in the key index list is found. The information stored in the key index list for this entry makes it possible to identify the points in a description stream at which the indexed entry is located in encoded form. The use of the key index list removes the need to decode data fragments that are of no interest, which means that less memory capacity is required during a query. Hunting through the key index list in order from top to bottom is time-consuming, however, and the sending of all of the paths indexed involves considerable outlay. The index structure itself, moreover, is of a significant size relative to the data stream indexed.

German Patent Application 10 337 825 in addition presents methods and devices that enable a bit stream to be generated from an indexing tree. However the approach described generates two documents, namely the encoded XML document and the bit stream, which includes index data of index nodes. The value expression in the XML document is referenced here with the aid of an indication of position.

### SUMMARY

An aspect is accordingly to disclose a method for encoding an XML-based document that allows both rapid querying of the encoded information and efficient encoding of the XML document in a straightforward and efficient manner.

A method for encoding an XML document in a bit stream in which the XML document is represented by a tree structure in which at least one absolute path is represented by a series of XML element and/or XML attribute names and at least one XML element has simple content sorts all absolute paths of the XML elements with simple content and XML attributes according to at least one first predeterminable sorting criterion, associates each value expression of the XML elements with simple content and of the XML attributes of the respective absolute path with a value representative in a value structure, it being the case that the value representative is stored in the value structure according to a second sorting criterion, and associates a path position with each value representative, it being the case that the path position represents a position of the respective value representative in the tree structure in relation to the respective absolute path.

The method for encoding makes it possible in an encoded bit stream, in particular a binary bit stream, not only to search in a rapid and straightforward manner for predeterminable search criterion, but also to permit efficient encoding of the XML document.

Further, a method for decoding an encoded bit stream, in particular a binary bit stream makes it possible to decode an encoded bit stream, in particular a binary bit stream, generated using the method for encoding an XML document.

Further, a method for encoding and decoding can be used both to encode an XML document into an encoded bit stream CB, in particular a binary bit stream, and to decode the encoded bit stream CB, in particular a binary bit stream, to produce a decoded XML document.

Further, an encoding device can be used to implement the method for encoding.

Further, a decoding device can be used to implement the method for decoding.

Further, an encoding and decoding device can be used to implement both the method for encoding and the method for decoding.

### BRIEF DESCRIPTION OF THE DRAWINGS

These and other aspects and advantages will become more apparent and more readily appreciated from the following description of the embodiments, taken in conjunction with the accompanying drawings of which:

FIG. 1 is text for an example of a structured XML document.

FIG. 2 is a bubble diagram providing an example of a representation of the structured XML document from FIG. 1 as a tree structure.

FIG. 3 is text for an example of a lexicographic sorting of the paths of the structured XML document from FIG. 1.

FIG. 4 is a data structure diagram of the bit stream after encoding of a structured XML document using the method.

FIG. 5 is a data structure diagram of the bit stream after encoding of a structured XML document using the method, with references to the value expressions.

FIG. 6 is a block diagram of a sorting tree for the absolute paths of the tree structure mapped in FIG. 2.

FIG. 7 is a block diagram of an exemplary serialization of the sorting tree presented in FIG. 6 for absolute paths.

### DETAILED DESCRIPTION OF THE EMBODIMENT

Reference will now be made in detail to the embodiments, examples of which are illustrated in the accompanying drawings, wherein like reference numerals refer to like elements throughout.

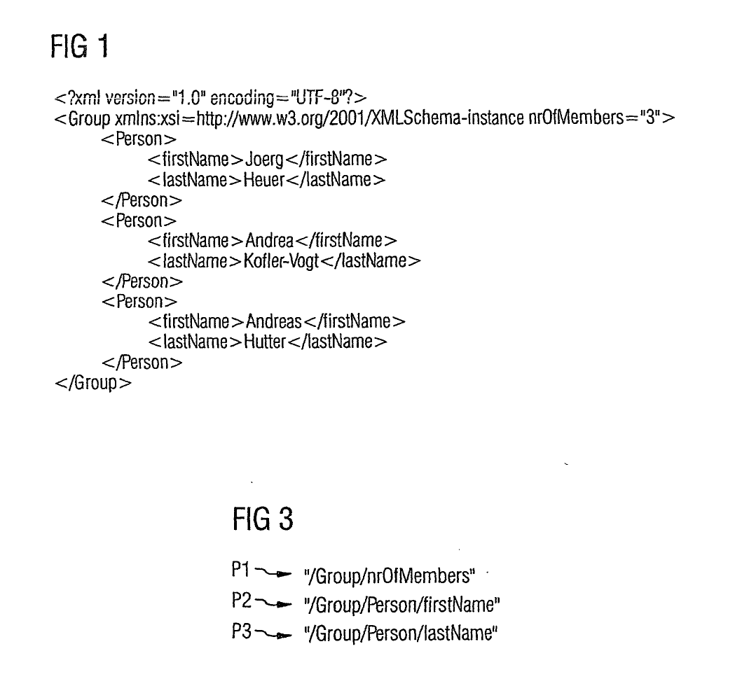

Elements having the same function and mode of operation are shown with the same reference characters in FIGS. 1 to 7.

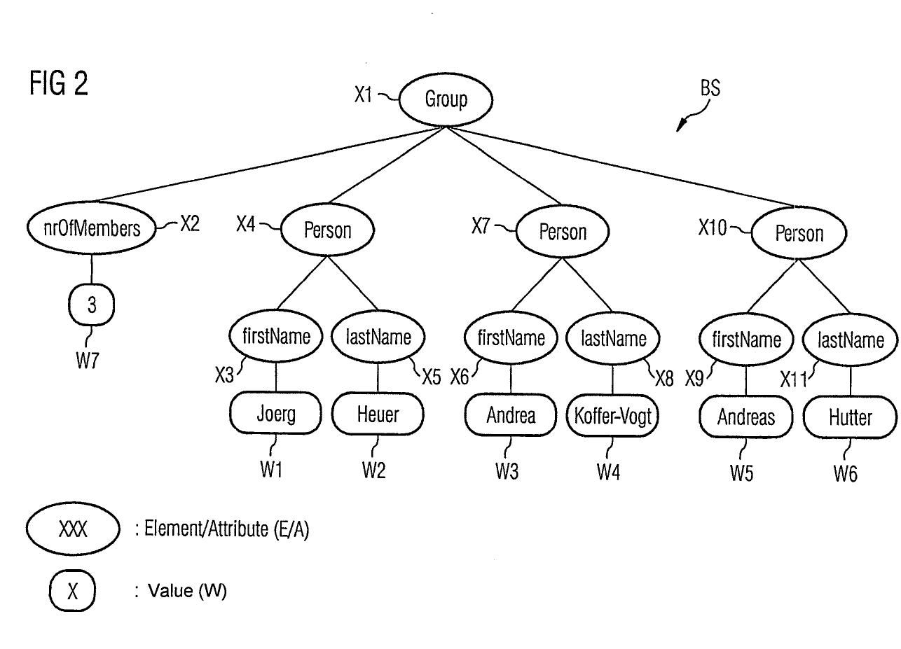

The method is explained in greater detail with reference to FIGS. 1 to 6. FIG. 1 shows an example of an XML document in text form. This XML document is mapped in FIG. 2 in the form of a tree structure (BS). The circles in this figure represent XML elements X1, X3 . . . , X11 and XML attribute X2. An XML document generally includes N XML elements and/or XML attributes X1, . . . , XN. XML elements with simple content and/or XML attributes X1, . . . , XN further include value expressions W1, . . . , WL that contain values such as “3” or “this year”, for example.

FIG. 3 shows multiple absolute paths P1, . . . , PM. The absolute paths P1, . . . , PM here identify a chain of XML elements with simple content and/or XML attributes X1, . . . , XN that are to be encoded. The absolute path P2=“/Group/Person/firstName”, for example, identifies the XML elements X9, X6 and X3. These absolute paths P1, . . . , PM lead to XML elements and XML attributes whose content is encoded and transmitted as type-specific values. The method provides for the absolute paths P1, . . . , PM to be sorted according to one first predeterminable sorting criterion S1. These absolute paths have been sorted into the order listed lexicographically in ascending order in the exemplary embodiment according to FIG. 3. The first sorting criterion S1 thus constitutes a lexicographic sorting algorithm. Another variant uses a static criterion, such as a number of XML elements with simple content and XML attributes per absolute path P1, . . . , PM, as the first sorting criterion S1. It can be seen from FIG. 2 that the absolute path P2 appears three times in the XML document:

- “/Group/Person/firstName” + “Joerg”
- “/Group/Person/firstName” + “Andrea”
- “/Group/Person/firstName” + “Andreas”

These three combinations can thus be written as follows using the absolute path P2=“/Group/Person/firstName”:

P2+“Joerg”

P2+“Andrea”

P2+“Andreas”

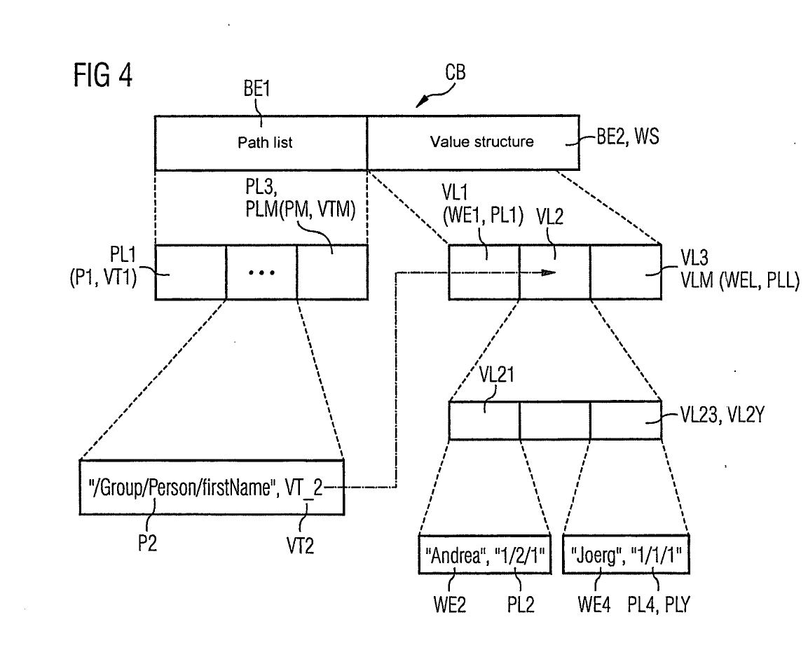

FIG. 4 shows a first exemplary embodiment of an encoded binary bit stream CB according to the method. This bit stream CB includes two bit stream elements BE1, BE2. Bit stream element BE1 contains a list with entries of absolute paths PL1, . . . , PLM. Each list entry PL1, . . . , PLM in this list includes an absolute path P1, . . . , PM and a link VT1, . . . , VTM to a value path list VL1, . . . , VLM in a value structure WS that corresponds to bit stream element BE2. The list with the list entries PL1, . . . , PLM is generated such that the absolute paths P1, . . . , PM are stored there according to the first predeterminable sorting criterion S1. The list entry PL1 thus includes the absolute path P1, the list entry PL2 of the absolute path P2 and the list entry PL2 of the absolute path P2, as the absolute paths are already sorted in FIG. 3.

The value structure WS in each case contains one value path list VL1, . . . , VLM per absolute path P1, . . . , PM. The value path list VL1, . . . , VLM contains a number of value expressions that are addressed by the respective absolute path P1, . . . , PM. Thus according to FIG. 2, by way of example, three different value expressions W1, W3, W5 are addressed by the absolute path P2. The value path list VL2 thus includes three value path elements VL21, . . . , VL23=VL2Y. The value element generally includes a value representative WE1, . . . , WEL in each case and a path position PL1, . . . , PLL in each case. The content of the value path element in the present exemplary embodiment is VL21 (WE2, PL2), VL22(WE3, PL3) and VL23(WE4, PL4). The other value path elements, such as VL11, are formed analogously.

The value representative WE1, WE2, WE3 in the present exemplary embodiment according to FIG. 4 contains the value expression W3, W5, W1. The association between value representative WE1, . . . , WEL and value expression W1, . . . , WL is made in one way according to the value expression W1, . . . , WL belonging to the respective absolute path P1, . . . . PM, but the respective value representatives WE1, . . . , WEL are also arranged according to a second sorting criterion S2 according to the method. The value representatives WE1, . . . , WEL can be arranged here, by way of example, according to an ascending lexicographic order of the respective value expressions W1, . . . , WL of the value representatives WE1, . . . , WEL. The value representative thus includes WE2=W3=“Andrea”, WE3=W5=“Andreas” and WE4=W1 “Joerg”.

The path position PL1, . . . , PLY contains indications as to which possible positions of the absolute path in the tree a value expression has been instanced in if multiple adjacent XML elements of the same name that are contained in the absolute path have been instanced. According to FIG. 2 the value expression W3=“Andrea” with the path “/Group/Person/firstName” would, for example, have the path position PL1=“1/2/1”, as “Andrea” is the value expression of the first “Group” element, the second “Person” element and the first “firstName” element. A path position is essential for the unambiguous reconstruction of the XML document in this example, as the XML element “Person” has multiple adjacent XML elements of the same name. Other methods for encoding the path position are disclosed in ISO/IEC 15938-1 Multimedia Content Description Interface—Part 1: Systems. The storage of the path position makes it possible to reconstruct the structured XML document with the instanced values in the original order.

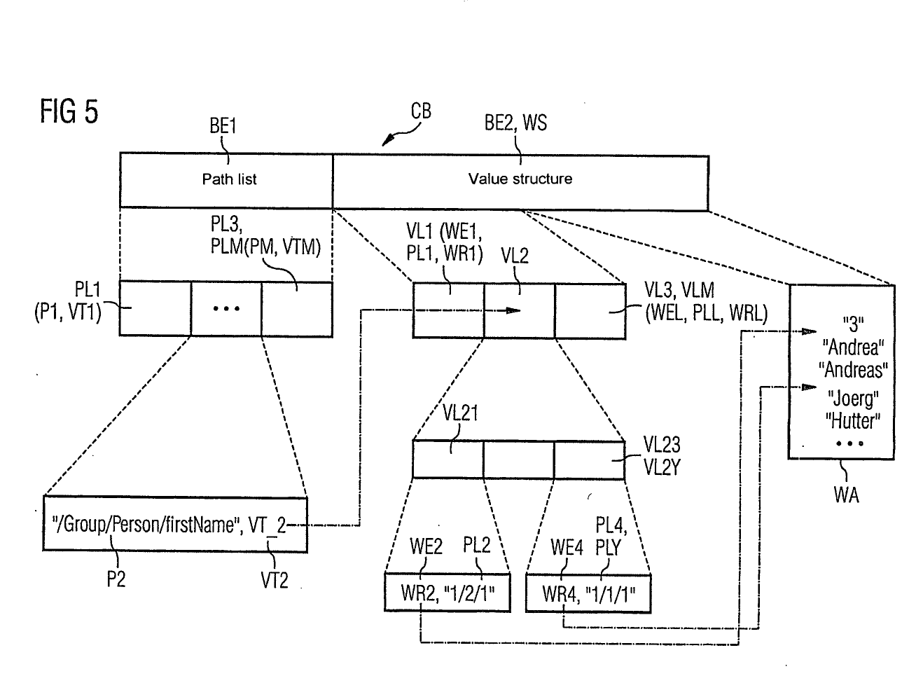

A variant of the method realizes a value representative W1, . . . , WL using a value link WR1, . . . , WEL to a value list WA. This is explained in greater detail with reference to FIG. 5. The exemplary embodiment of FIG. 5 differs merely in the creation of the value representatives WE1, . . . , WEL. Instead of transferring them directly into the respective value representatives WE1, . . . , WEL, this exemplary embodiment according to FIG. 5 references the value expressions W1, . . . , WL by the value link WR1, . . . , WRL to the value list WA. The value list WA contains the value expressions W1, . . . , WL. These can be stored in a sorted order in the value list WA. It is also possible to represent value expressions W1, . . . , WL, which occur every so often, just by a value expression, as the respective value link WR1, . . . , WRL ensures an unambiguous association between value representative and an entry in the value list WA.

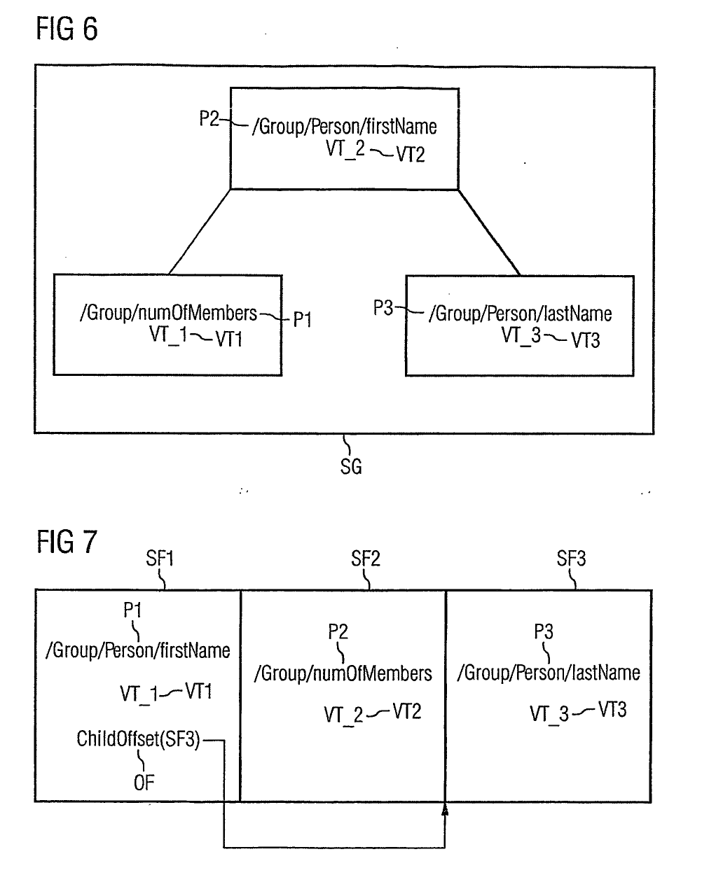

A variant of the method provides for the absolute path P1, . . . , PM and/or the value representative WE1, . . . , WEL of the respective value path list VL1, . . . , VLM of the value structure WS to be sorted in a respective sorting tree. FIG. 6 shows a first sorting tree SG for the absolute paths P1, . . . , PM according to the exemplary embodiment according to FIG. 2. Methods for creating sorting trees SG of this type are known from German Patent Application 10 337 825. The use of a sorting tree SG instead of linear lists such as the list of absolute paths BE1, for example, considerably reduces the complexity of searching.

An extension of the method provides for the sorting tree SG to be inserted in a serialized form into the encoded bit stream CB. A method for creating this serialized form is known from German Patent Application 10 337 825. FIG. 7 shows a realization example for the first sorting tree SG known from FIG. 6. A serialized field SF1, . . . , SFM, for example, is generated for each list entry of an absolute path PL1, . . . , PLM. A serialized field SF1, . . . , SFM here includes at least the absolute path P1, . . . , PM and the link VT1, . . . , VTM. The serialized field SF2 contains the absolute path P2 and the link VT2, for example. It is also possible for an additional offset OF that enables serialized fields SF1, . . . , SFM that are not relevant to be skipped over to be contained in one or more serialized fields SF1, . . . , SFM. The offset OF(SF3) thus indicates the point in the encoded bit stream CS at which the next relevant serialized field SF3 is to be found.

It is further possible according to the method for the absolute path P1, . . . , PM to be represented by a relative path relative to previously sorted paths. The only difference between absolute paths P2=“/Group/Person/firstName” and P3=“/Group/Person/lastName” is the “firstName”/“lastName” component. Methods for generating relative paths from absolute paths are known from publication German Patent Application 10 337 825. The use of relative paths can bring about a further reduction in the volume of data needed for the encoded bit stream.

A further variant of the method provides for the value expression W1, . . . , WL and/or the absolute path P1, . . . , PM and/or the relative path and/or the path position (PL1, . . . , PLL) to be encoded in a binary code. Binary encoding makes it possible to reduce the data volume of the encoded bit stream CS. Binary encoding can be carried out according to the MPEG-7 standard.

It is also possible for at least one XML element with complex content, for example the XML element X4, to be treated like an XML element with simple content, for example the XML element X3, and to encode content of the XML element with complex content as a value expression, in particular according to an MPEG-7 standard. Taking the XML element X4 as an example, the XML elements X3, X5 and the value expressions W1, W2 are treated as value expressions. This would reduce the quantity of absolute paths to two possibilities, “/Group/nrOfMembers” and “/Group/Person”, which makes it possible to reduce the complexity of searching even further in cases in which the complex content is considered purely in the manner of context when the information is called. The procedure according to the method can thus also be applied to XML elements with complex content.

Further, a method for decoding an encoded bit stream CB that has been generated using the method for encoding an XML document. The method for decoding is also able to decode an encoded binary bit stream CB.

In addition, a method for encoding and decoding is able not only to encode an XML document as an encoded bit stream CB, in particular an encoded binary bit stream, but also to decode the encoded bit stream CB, in particular an encoded binary bit stream, to produce a decoded XML document.

An XML document can be encoded and an encoded bit stream CB, in particular an encoded binary bit stream, can be decoded to produce a decoded XML document. An encoding and decoding device can be used to encode an XML document as an encoded bit stream CB, in particular an encoded binary bit stream, and also to decode an encoded bit stream CB, in particular an encoded binary bit stream, to produce a decoded XML document. The encoding device and/or decoding device and/or encoding and decoding device can be integrated into an item of equipment according, for example, to the GSM (Global System for Mobile Communications) standard or a UMTS (Universal Mobile Telecommunications System) standard. The device can furthermore be realized in an item of equipment that is connected to a wired network such as a network based on IP (Internet Protocol) or ISDN (Integrated Services Digital Network).

The scope is by no means limited to the exemplary embodiments discussed; indeed the following variants and/or advantages constitute additional and/or alternative subject matter. In structured documents, in particular XML documents, the type of information in an XML element or XML attribute of a document is declared by the name of all father elements. The XML elements and XML attributes are arranged here in a document tree according to a structure definition. The method for encoding the structured document sorts all XML elements with simple content, XML elements whose values are to be encoded in connection and XML attributes according to their name and the name of their father elements, that is to say in accordance with their path according to any desired criteria, for example lexicographically. The paths here are absolute paths that start from the root node of the document structure tree and lead to a leaf node of the document structure tree. The values of all XML attributes and XML elements having the same path are stored in a data area that is identified by the common path. The entries in the data area are sorted in accordance with their values according to any desired criteria, for example lexicographically. Each entry in this data area is stored with the path position at which the entry appeared in the structured document. This makes it possible to reconstruct the structured document in full from the data encoded.

One embodiment has not the actual values but rather links to the values stored in the data area identified by a path. This avoids the repeated storage of values insofar as multiple references, which occupy less memory capacity, link to one value.

The sorted paths in an especially preferred embodiment are arranged in a serialized sorting tree. A sorting tree includes a multiplicity of hierarchical levels, it being the case that each hierarchical level is associated with one or more nodes and that the nodes contain sorted data, for example the paths, that is sorted in the sorting tree according to one or more predetermined criteria. The sorted data of the nodes is inserted into the bit stream during serialization, and in addition the information identifying the point in the bit stream at which the data of one or more nodes of the hierarchical level situated below the hierarchical level of the node concerned can be found is inserted into the bit stream for each node. Storing the additional information regarding the nodes in a lower hierarchical level renders searching for specific data much more straightforward, as it makes it possible to jump to the nodes relevant to the search. This ensures much more efficient querying and searching for data.

The serialized sorting tree in a further embodiment is structured as what is known as a B-tree (balanced tree), which ensures a balanced distribution of the paths across the nodes of the tree. A detailed description of the B-tree could be found at www.public.asu.edu/˜peterjn/btree/ when the priority application was filed.

The paths in a further variant are inserted into the bit stream according to depth-first ordering. The use of depth-first ordering means that the sorted data in the sorting tree is initially inserted into the bit stream according to depth, as a result of which the items of information in the bit stream that are of relevance for a query are arranged adjacent to one another and items of information that are not relevant can be skipped over efficiently. A detailed description of depth-first ordering could be found at www.generation5.org/simple_search.shtml when the priority application was filed.

The paths in one embodiment are relative paths, it being the case that a relative path of a node in each case is a path relative to a path, which path has previously been inserted into the bit stream, of the node concerned or of a node of a hierarchical level lying above the hierarchical level of the node concerned. The use of relative paths exploits commonalties in the paths, as the paths of adjacent nodes usually have a common portion. The memory capacity needed for the sorted data in the bit stream can thus be reduced. A further reduction in the memory capacity needed can be brought about by inserting the paths of the node whose sorted data is inserted into the bit stream as the first sorted data from a hierarchical level into the bit stream in an order that is the reverse of the order in which the sorted data is arranged in the node. This takes account of the fact that the sorted data at the end of the first node of a hierarchical level is more similar to the sorted data of the node of the next higher hierarchical level than the sorted data at the beginning of the first node. Consequently encoding using relative paths can prove to be particularly effective in certain cases.

The paths in a further embodiment include description elements of an XML (extensible markup language) document, it being the case that the paths are in particular XPath paths of the XML document.

In another variant the index data is binary encoded using an encoding method, in particular using an MPEG encoding method. The MPEG-7 encoding method is used as the encoding method in a particular embodiment.

The values are arranged in a serialized sorting tree in an embodiment.

The values are inserted into the bit stream according to depth-first ordering in an embodiment.

The values in the data area are binary encoded using an encoding method, in particular an MPEG encoding method, in another embodiment. The MPEG7 encoding method is used as the encoding method in an embodiment.

The path position is binary encoded using an encoding method, in particular an MPEG encoding method, in another embodiment. The MPEG7 encoding method is used as the encoding method in an embodiment.

A description has been provided with particular reference to embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A method for encoding an XML document in a binary bit stream, where the XML document is represented by a tree structure in which at least one absolute path is represented by a series of XML element or attribute names and at least one XML element has simple content, said method comprising:
sorting all absolute paths of the XML elements with simple content and XML attributes according to at least one first predeterminable sorting criterion;
associating each value of the XML elements having simple content and the XML attributes of a respective absolute path, with a value representative in a value structure, where the value representative is used in the value structure according to a second sorting criterion;
associating each value representative with a path position, where the path position represents a position of the respective value representative in the tree structure in relation to the respective absolute path.

17. The method as claimed in claim 16, wherein the value is used as a value representative in the value structure.

18. The method as claimed in claim 16, wherein the value representative is realized using a value link to a value list.

19. The method as claimed in claim 18, wherein at least one of the absolute path and the value representative of a respective value path list of the value structure are sorted in a respective sorting tree.

20. The method as claimed in claim 19, wherein the respective sorting tree is inserted in a serialized form into the encoded bit stream.

21. The method as claimed in claim 20, wherein the absolute path is represented by a relative path relative to previously sorted paths.

22. The method as claimed in claim 21, wherein at least one relative and/or absolute path is binary encoded, according to an MPEG-7 standard, in the bit stream.

23. The method as claimed in claim 22, wherein the value is binary encoded in the bit stream.

24. The method as claimed in claim 23, wherein at least one XML element with complex content is treated as if the complex content were simple content and the complex content is encoded as a value according to the MPEG-7 standard.

25. The method as claimed in claim 24, wherein the path position is binary encoded in the bit stream using the MPEG-7 standard.

26. A method for decoding the binary bit stream encoded as claimed in 16.

27. A method comprising:
encoding an XML document in a binary bit stream as claimed in claim 16; and
decoding the binary bit stream encoded as claimed in 16.

28. An encoding device, comprising means for encoding an XML document in a binary bit stream as claimed in claim 16.

29. A decoding device, comprising means for decoding the binary bit stream encoded as claimed in 16.

30. A device, comprising:
means for encoding an XML document in a binary bit stream as claimed in claim 16; and
decoding the binary bit stream encoded as claimed in 16.
